(19) United States
(12) Patent Application Publication
(10) Pub. No.: US 2026/0163436 A1
(43) Pub. Date: Jun. 11, 2026

(54) SYSTEMS FOR AN ELECTRIC MOTOR

(71) Applicant: DANA TM4 INC., BOUCHERVILLE (CA)

(72) Inventors: Simon BAKER-OSTIGUY, Montreal (CA); Guillaume PAYEUR, Boucherville (CA)

(21) Appl. No.: 19/408,189

(22) Filed: Dec. 3, 2025

Related U.S. Application Data
(60) Provisional application No. 63/729,016, filed on Dec. 6, 2024.

(51) Int. Cl. H02K 3/50

(52) U.S. Cl. CPC H02K 3/50; H02K 2203/09

(57) ABSTRACT

Methods and systems are provided for an electric motor. The electric motor includes a plurality of posts extending through a cover at a first end and integrated with a busbar assembly at a second end, a busbar support plate pressing against the cover, the busbar support plate including an opening through which at least one post of the plurality of posts extends, a plurality of radial seals arranged in the plurality of posts, and a plurality of axial seals arranged in the busbar support plate.

### CROSS REFERENCE TO RELATED APPLICATIONS

The present application claims priority to U.S. Provisional Application No. 63/729,016, entitled “SYSTEMS FOR AN ELECTRIC MOTOR”, and filed on Dec. 6, 2024. The entire contents of the above-listed application are hereby incorporated by reference for all purposes.

### FIELD

The present description relates generally to a busbar for an electric motor. More specifically, the present disclosure relates to sealing the busbar of an electric motor.

### BACKGROUND AND SUMMARY

Electric motors may include a stator busbar assembly coupled to stator windings. Intermediate busbars may be coupled to the stator busbar assembly at a first end and to inverter leads at a second end opposite the first end. In applications with higher voltage cables extending to the inverter, the intermediate busbars may be fastened to a terminal block that interfaces with the high voltage cables.

For an oil cooled electric motor, the interface between the high voltage cables, a terminal block, and intermediate busbars may be sealed to prevent oil leakage. Preexisting oil cooled motors may include complex sealing elements and large packaging sizes. Alternatives to preexisting configurations are desired.

The issues described above may be addressed by an electric motor including a plurality of posts extending through a cover at a first end and integrated with a busbar assembly at a second end, a busbar support plate pressing against the cover, the busbar support plate comprising an opening through which at least one post of the plurality of posts extends, a plurality of radial seals arranged in the plurality of posts, and a plurality of axial seals arranged in the busbar support plate.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a vehicle system with a transmission and an electric motor.

FIG. 2 shows a motor cover side of the electric motor.

FIG. 3 shows a cutaway of the electric motor exposing windings of the electric motor.

FIG. 4A shows a mold of a busbar assembly.

FIG. 4B shows a welding of the busbar assembly.

FIG. 5 shows an alternative example including long posts that are fastened to the busbars.

FIGS. 6A and 6B show individual sealing elements for the long posts based on the embodiment of FIG. 5.

### DETAILED DESCRIPTION

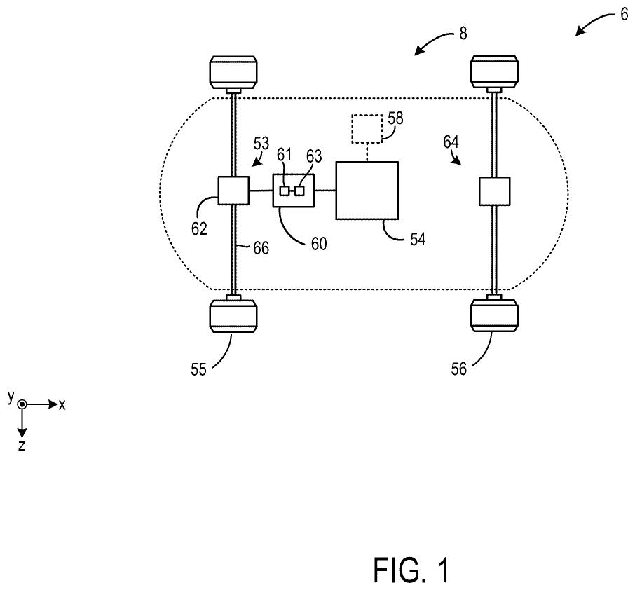

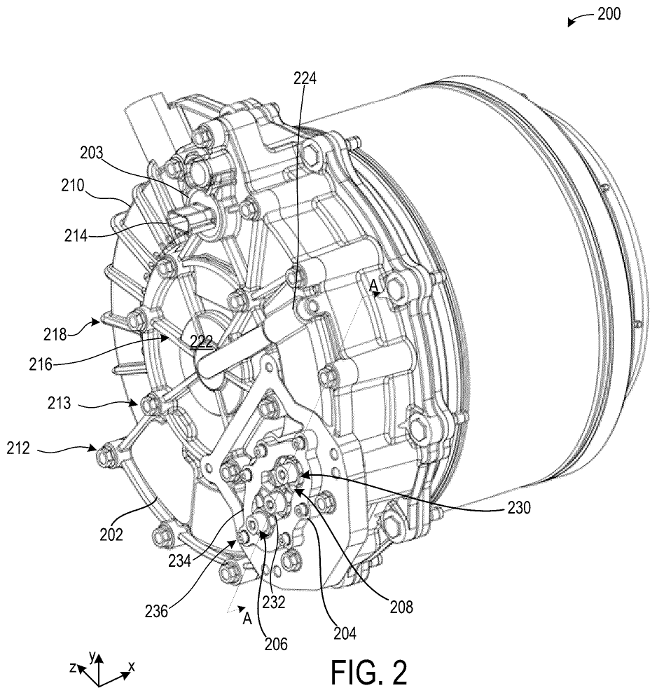

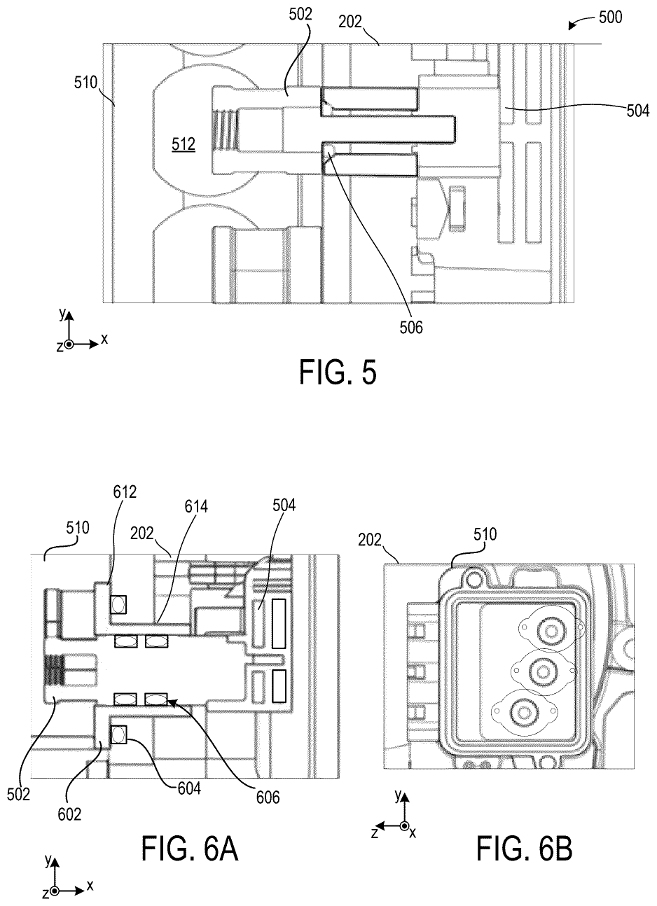

The following description relates to systems for a vehicle, as shown in FIG. 1. The vehicle may include an electric motor including busbars welded to windings are shown in FIG. 2. A mold may seal the busbars as shown in FIGS. 2-4B. An alternative example of the mold is shown in FIGS. 5, 6A, and 6B.

The disclosure relates to an electric motor busbar and method of sealing for oil-cooled electric motors, addressing several technical challenges in the interface between the stator busbar assembly and high voltage cables. In conventional electric motor systems, intermediate busbars (either rigid or flexible) are required to connect the stator busbar assembly to the inverter leads or terminal block. For oil-cooled motors, this interface is sealed to prevent oil leakage, typically requiring pass-through connectors with O-ring seals or gaskets. Additionally, tolerance stackup and misalignment between the stator busbar and motor cover present significant sealing challenges that may be difficult to accommodate.

The present disclosure at least partially solves the above described problems related to conventional electric motor cooling system designs by eliminating the intermediate busbars entirely and integrating long posts directly into the stator busbar assembly. These long posts protrude through the motor cover and provide tapped holes for direct fastening to the high voltage cables. The stator busbar assembly may include busbars welded to the stator windings, long posts fixed to the busbars through staking, riveting, or welding, and a plastic overmold that provides structure and electrical isolation. The long posts feature grooves to accommodate radial seals, such as O-rings or other radial gaskets.

The sealing system employs a busbar support plate with cylindrical bores that fit over the busbar posts and seal against the radial o-rings on the posts. The support plate is positioned radially in space by the busbar posts but remains free to slide axially until it abuts against the motor cover. An axial gasket between the support plate and motor cover prevents oil leakage at that interface. This combination of radial seals on the posts and an axial seal between the support plate and motor cover allows the system to accommodate significant misalignment between the stator busbar and motor cover, eliminating the need for extremely tight tolerances.

The configuration of the present disclosure minimizes both axial and radial packaging space, allowing for a more compact motor assembly. By eliminating intermediate busbars, the solution reduces part count, cost, assembly cycle time, and the risk of component failure. The integrated long posts prevent leak paths that would otherwise occur if separate spacers were fastened to short posts on the stator busbar assembly. The configured of the present disclosure allows high voltage cables to route directly to the face of the motor housing with the interface located parallel to the motor axis, rather than perpendicular to it or protruding far behind the motor cover as in conventional designs. This allows for tighter packaging space behind the motor cover. The support plate can be designed as a single piece interfacing with multiple busbar posts simultaneously, which is the optimal configuration for minimizing radial and axial packaging space, though alternative designs with individual plates per post are also possible. The clearance holes in the support plate are sized to provide radial clearance for fasteners to accommodate misalignment and radial tolerance stackup. Overall, the invention provides robust sealing regardless of tolerance stackup and misalignment while simplifying the design and reducing complexity.

In an effort to improve the packaging and provide a simpler example of sealing the motor/high voltage cable interface, the intermediate busbars of the previous examples were deleted and the stator busbar assembly was shaped with long integrated lugs that protrude from the motor cover and are sealed by a busbar support plate. The high voltage cable scan directly fastens to the stator busbar assembly without intermediate busbars. The busbar support plate and its seals are arranged to provide robust sealing regardless of tolerance stack up and misalignment between the stator busbar and the motor cover.

The stator busbar assembly includes busbars, long posts with tapped holes, and a plastic overmold. The busbars are welded to the stator windings. The long posts are fixed to the busbars using different means., such as staking, riveting or welding. The plastic overmold provides structure and electrical isolation over this assembly. The long posts may include grooves to provide a gland for a radial seal, such as an O-ring or a different form of radial gasket. The end of the posts includes a tapped hole and can include an insert to increase the thread strength. The posts and busbars can be made of copper, aluminum, brass or other conductive materials.

The long posts protrude from the motor cover. A busbar support plate seals the gaps between the posts and the motor cover. The support plate has cylinders with bores that fit over the busbar posts and seal on the O-rings. The support plate is located radially in space by the busbar posts and is free to slide axially until it abuts against the motor cover. There is an axial gasket between the support plate and the motor cover that prevents oil from leakage out of that interface.

The radial O-rings seal the interface between the posts and the support plate, and the axial gasket seals the interface between the support plate and motor cover. The combination of an axial seal and radial seals allow the support plate to seal despite radial misalignment between the posts and the motor cover. There can be one, two, or more radial seals on each post.

The support plate in the present disclosure includes one piece that interfaces with all three busbar posts. This allows the busbar posts to be packaged close together and the axial seal takes up less room. In another example of the present disclosure, individual busbar support plate could be configured for each post such that there is one plate per post. Each plate may include a cylindrical bore to seal against the post and an axial gasket to seal against the housing. In a further example, the axial seal is replaced by a radial seal. The misalignment between the post and housing is mitigated because the support plates are free to tilt radially while still sealing against the post and the housing.

The present disclosure can be shaped to interface with any number of busbar posts. In the images there are three, however it may be less than or more than three without departing from the scope of the disclosure.

The support plate is fastened to the motor cover to provide axial clamping on the axial gasket. The clearance holes in the support plate are sized to provide radial clearance for the fasteners for misalignment/radial tolerance stackup.

FIG. 1 shows a schematic depiction of a vehicle 6 with a powertrain 8 that may include a prime mover 54 and a transmission 60. In some examples, the prime mover 54 may be an electric motor (e.g., a traction motor). In such an example, the electric motor may be electrically connected to an energy storage device 58 (e.g., one or more traction batteries, capacitors, fuel cells, combinations thereof, and the like). Further, in the electric motor example, the motor may be configured to operate as a generator, during selected conditions, to provide electrical power to charge the energy storage device 58, for example. In other examples, the prime mover 54 may be an internal combustion engine. Therefore, the vehicle 6 may be a hybrid vehicle, an all-electric vehicle, or an internal combustion engine vehicle.

In the illustrated example, the transmission 60 delivers mechanical power to a differential 62 of an axle assembly 53. However, it will be appreciated that the transmission 60 may additionally or alternatively deliver mechanical power to the other axle 64 in the vehicle 6. Still further, in other examples, the transmission may be incorporated into one of the axles to form an electric axle assembly. In the electric axle example, an internal combustion engine may provide mechanical power to the other axle, in some cases.

The transmission 60 (e.g., a gearbox) may be configured to receive torque from the prime mover 54 via a shaft (e.g., a drive shaft) and/or other suitable mechanical component. The transmission 60 may include at least one actuator 61. The actuator 61 may be a barrel cam actuator for shifting between gears. The actuator 61 in the transmission 60 may adjust a position of one or more shift forks, such as a shift fork 63, which may in turn adjust a position of one or more clutches.

Further, the transmission 60 may output torque to the differential 62. The output torque may be moderated based on selective adjustments to gear engagement at the transmission 60 to accommodate desired vehicle operation. Torque from the transmission 60 may drive rotation of the differential 62, which may in turn drive rotation of axle shafts 66 which are rotationally coupled to vehicle wheels 55.

FIG. 2 shows an electric motor 200. The electric motor 200 may be a non-limiting example of prime mover 54 of FIG. 1. The electric motor 200 may include an electric motor cover 202 physically coupled to an electric motor housing 210 via a first plurality of fasteners 212 and a second plurality of fasteners 213. The first plurality of fasteners 212 may extend around an outer circumference of the cover 202 and the second plurality of fasteners 213 may extend around an inner circumference of the cover 202. In some examples, the motor housing 210 and the motor cover 202 may be integrated as a single piece. Additionally, or alternatively, the housing or housings may be part of a larger gearbox or drive unit assembly.

The motor cover 202 may further include an opening 203 through which an electric port 214 extends. The electric port 214 may be configured to receive a connector or other similar device, which may provide electric power to the electric motor 200.

The motor cover 202 may further include a plurality of ribs 216 that are misaligned with a plurality of ribs 218 of the motor housing 210. The plurality of ribs 216 may extend from a central protrusion 222 of the electric motor cover 202. A radial protrusion 224 may extend from the central protrusion 222 and through one or more of the plurality of ribs 216. In one example, the radial protrusion 224 may be larger than each of the plurality of ribs 216.

A busbar support plate 204 may be physically coupled to the motor cover 202 to provide axial clamping on an axial gasket. Clearance holes 208 in the support plate may be sized to provide radial clearance for the plurality of fasteners for misalignment and/or radial tolerance stack-up.

A plurality of posts 206 may protrude from the motor cover 202. Herein, the plurality of posts 206 may be interchangeably referred to herein as a plurality of long posts 206. The busbar support plate 204 may seal gaps between the plurality of long posts 206 and the motor cover 202. The support plate 204 may include cylinders 230 with bores that fit over the plurality of long posts 206 and seal on the O-rings. The busbar support plate 204 is located radially in space by the plurality of long posts 206 and is free to slide axially until it abuts against the motor cover 202. There is an axial gasket between the busbar support plate 204 and the motor cover 202 that prevents oil from leakage out of the interface between the busbar support plate 204 and the motor cover 202. In one example, misalignment between the stator busbars and motor housing is solved by the combination of axial and radial seals, described in greater detail below. The seals may mitigate misalignment and reduce the demand for precise tolerances or intermediate busbars.

The busbar support plate 204 may include a plurality of ribs 232. The plurality of ribs 232 may shape a web-like structure between the plurality of cylinders 230 and an outer rim 234 of the busbar support plate 204. The web-like structure includes the ribs 232 shaping the clearance holes 208 in the area between the outer rim 234 and the plurality of cylinders 230.

A plurality of fasteners 236 may physically couple the busbar support plate 204 to the motor cover 202. The plurality of fasteners 236 may extend around a perimeter of the outer rim 234. In one example, the busbar support plate 204, including the plurality of fasteners 236, the plurality of ribs 232, and the cylinders 230, is symmetric about a radial axis. In one example, the plurality of fasteners 236 may physically couple the busbar support plate 204 in a face-sharing arrangement to the motor cover 202.

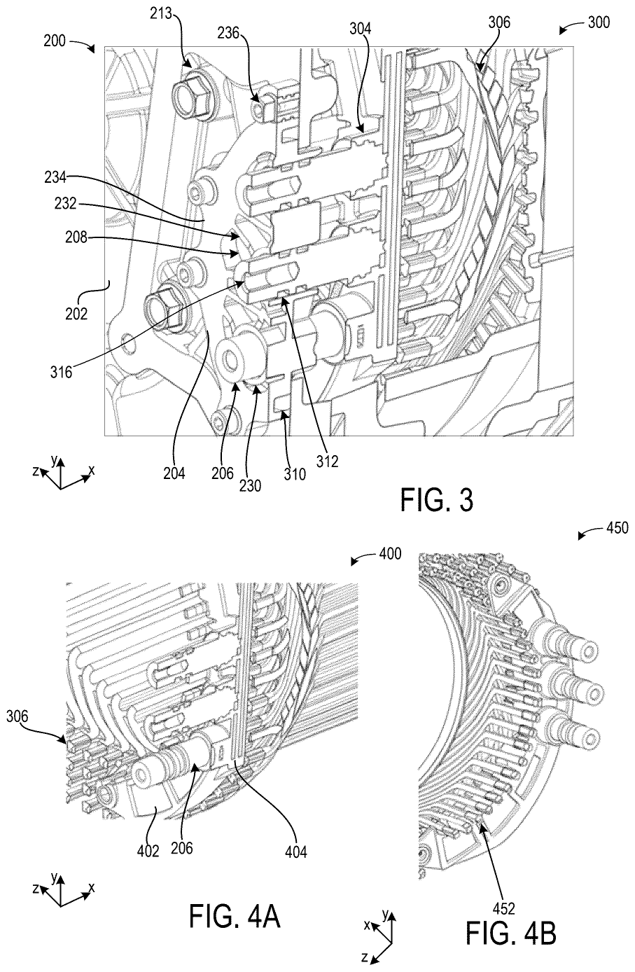

Turning now to FIG. 3, it shows a cutaway view 300 exposing an interior of the electric motor 200 along cutting plane A-A of FIG. 2. A stator busbar assembly 304 is shown extending around the plurality of long posts 206 and coupled to a plurality of windings 306. The stator busbar assembly 304 may be positioned around a second end of the plurality of long posts 206, wherein a first end of the plurality of long posts 206 extends through the motor cover 202. In one example, the plurality of long posts 206 are integrally arranged in the stator busbar assembly 304 to eliminate a potential leak path. The plurality of long posts 206 may be fixed to the busbars via staking, riveting, or welding. In one example, the first ends of the plurality of long posts 206 are exposed and extend out of the motor cover 202 and the busbar support plate 204. The second ends of the plurality of long posts 206 may be arranged within the housing of the electric motor 200. More specifically, the second ends may be integrally coupled with the stator busbar assembly 304 and the first ends may protrude through the cover into an area in which a port cover may be arranged. The first ends of the plurality of long posts 206 may include tapped holes 316 that are configured to fasten to cables and/or wires.

A plurality of axial seals 310 and a plurality of radial seals 312 are shown arranged in various grooves of the busbar support plate 204. The plurality of axial seals 310 may be arranged between the plurality of long posts 206 and a plurality of fasteners 236236 (herein, interchangeably referred to as the plurality of support plate fasteners 236). The plurality of support plate fasteners 236 may be arranged along an outer diameter of the busbar support plate 204 while the plurality of long posts 206 is arranged radially interior to the plurality of support plate fasteners 236. The radial seals 312 may seal the interface between the plurality of long posts 206 and the busbar support plate 204. The axial seals 310 may seal the interface between the busbar support plate 204 and motor cover 202. The combination of the plurality of axial seals 310 and the plurality of radial seals 312 allow the busbar support plate 204 to be sealed despite radial misalignment(s) between the plurality of long posts 206 and the motor cover 202. In this way, the installation of the busbar support plate 204 and its sealing to the cover plate 202 may be simplified via the axial and radial seals accounting for play and other misalignments. As such, the installation may be faster and simpler. There may be one, two, or more radial seals on each of the plurality of long post 206.

In one example, the plurality of radial seals 312 is integrally arranged in the plurality of long posts 206. For example, the plurality of long posts 206 may include grooves to provide a space for each radial seal of the plurality of radial seals 312, such as an O-ring or a different form of radial gasket. The first ends of the plurality of long posts 206 may include a tapped hole through which an insert may be arranged to increase a thread strength.

The busbar support plate 204 may be one piece that interfaces with the plurality of long posts 206. This allows the plurality of long posts 206 to be packaged close together while also allowing a packaging of the plurality of axial seals 310 to be smaller.

FIG. 4A shows busbars 402 in example 400 that may be welded to the plurality of windings 306. Welds 452 are shown in the example 450 of FIG. 4B. The plurality of long posts 206 and busbars 402 comprise one or more of copper, aluminum, brass, and other conductive materials. A mold 404 may extend around each of the plurality of plurality of long posts 206 and the busbars 402. The mold 404 is a plastic overmold, in one example. The mold 404 may be arranged between the busbar support plate 204 and the plurality of windings 306. The mold 404 may provide structure and electrical isolation over the busbar assembly.

In this way, FIGS. 2-4B illustrate an electric motor include a busbar support plate and a plurality of long busbar posts. The plurality of long busbar posts may extend through an electric motor cover and provide tapped holes to fasten electric cables. By doing this, a demand for an intermediate busbar may be eliminated. Additionally, an assembly cycle time may be faster, a part count may be reduced which may decrease manufacturing costs. In this way, a method for sealing the stator busbar and high voltage cable interfaces with a reduced number of parts and more compact package is provided by the embodiment of FIGS. 2-4B. Additionally, the packaging space behind the motor cover is utilized, as opposed to the side of the motor as seen in previous examples.

FIGS. 5-6B show an alternative embodiment 500 where a plurality of long posts 502 that are fastened to the busbars 504. In this way, the plurality of long posts 502 are not integrated into the busbar assembly as depicted in the examples FIGS. 3-4B. The plurality of long posts 502 may include seals 506 as shown. The plurality of long posts 502 are shown extending in a direction normal to openings 512 of a port cover 510. In such an example, an individual busbar support plate 602 may be shaped for each of the plurality of long posts 502. Each busbar support plate 602 may include a cylindrical bore to seal against a long post of the plurality of long posts 502 and an axial seal 604 to seal against the port cover 510. In another example, the axial seal 604 is replaced by a radial seal. A plurality of radial seals 606 may be positioned between the support plate 602 and each of the plurality of long posts 502. The misalignment between the post and housing is mitigated because the support plates are free to tilt radially while still sealing against the post and the housing. The example of FIGS. 5-6B may demand more axial length than the example of FIGS. 2-4B.

The support plate 602 may include an L-shaped cross-sectional shape. That is to say, the support plate 602 may include a rim 612 and a body 614, wherein the rim 612 extends in a direction normal to the body 614. In one example, the rim 612 may be positioned at an interface between the port cover 510 and the motor cover 202. In one example, a length of the rim 612 may be smaller than a length of the body 614. The axial seal 604 may be pressed against each of the rim 612 of the support plate 602 and the motor cover 202. The plurality of radial seals 606 may be pressed against the plurality of long posts 502 and the body 614 of the support plate 602.

FIGS. 2-6B are drawn approximately to scale. FIGS. 2-6B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The disclosure also provides support for an electric motor including a plurality of posts extending through a cover at a first end and integrated with a busbar assembly at a second end, a busbar support plate pressing against the cover, the busbar support plate comprising an opening through which at least one post of the plurality of posts extends, a plurality of radial seals arranged in the plurality of posts, and a plurality of axial seals arranged in the busbar support plate. In a first example of the system, the opening is one or a plurality of openings, and wherein the busbar support plate is a single piece comprising the plurality of openings through which the plurality of posts extends. In a second example of the system, optionally including the first example, a number of busbar support plates is equal to a number of posts of the plurality of posts. In a third example of the system, optionally including one or both of the first and second examples, the busbar assembly is welded to a plurality of windings. In a fourth example of the system, optionally including one or more or each of the first through third examples, the plurality of radial seals is configured to seal an interface between the plurality of posts and the busbar support plate. In a fifth example of the system, optionally including one or more or each of the first through fourth examples, the plurality of axial seals is configured to seal an interface between the busbar support plate and the cover. In a sixth example of the system, optionally including one or more or each of the first through fifth examples, the plurality of posts comprises through-holes through which cables extend. In a seventh example of the system, optionally including one or more or each of the first through sixth examples, the system further comprises: an overmold configured to provide structure to and electrically isolate the busbar assembly.

The disclosure also provides support for a system including a plurality of posts that protrudes through a housing of an electric motor and a motor cover, and a busbar support plate arranged radially about the plurality of posts and in face-sharing contact with an outer surface of the motor cover. In a first example of the system, the plurality of posts comprises tapped holes configured to receive cables, and wherein the plurality of posts extends to a stator busbar assembly. In a second example of the system, optionally including the first example, the plurality of posts comprises grooves in which a plurality of radial seals is arranged, wherein the plurality of radial seals is in face-sharing contact with the plurality of posts and the busbar support plate. In a third example of the system, optionally including one or both of the first and second examples, the busbar support plate comprises grooves in which a plurality of axial seals is arranged, wherein the plurality of axial seals is in face-sharing contact with the busbar support plate and the motor cover. In a fourth example of the system, optionally including one or more or each of the first through third examples, the plurality of posts extends through a plurality of chambers of the busbar support plate. In a fifth example of the system, optionally including one or more or each of the first through fourth examples, the busbar support plate comprises a web-structure between the plurality of chambers and an outer rim. In a sixth example of the system, optionally including one or more or each of the first through fifth examples, the busbar support plate is symmetric.

The disclosure also provides support for an electric motor including a stator busbar assembly arranged in a housing of the electric motor, a busbar support plate arranged in face-sharing contact with an outer surface of a motor cover coupled to the housing, and a plurality of posts that protrudes through a housing of an electric motor and a motor cover and extend to the stator busbar assembly. In a first example of the system, the plurality of posts comprises grooves in which a plurality of radial seals is arranged, wherein the plurality of radial seals is in face-sharing contact with the plurality of posts and the busbar support plate. In a second example of the system, optionally including the first example, the busbar support plate comprises grooves in which a plurality of axial seals is arranged, wherein the plurality of axial seals is in face-sharing contact with the busbar support plate and the motor cover. In a third example of the system, optionally including one or both of the first and second examples, the plurality of posts integrated into the stator busbar assembly. In a fourth example of the system, optionally including one or more or each of the first through third examples, each of the plurality of posts is individually fastened to the stator busbar assembly, and wherein each post of the plurality of posts comprises a sealing plate with axial and radial seals.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric motor, comprising:
a plurality of posts extending through a cover at a first end and integrated with a busbar assembly at a second end;
a busbar support plate pressing against the cover, the busbar support plate comprising an opening through which at least one post of the plurality of posts extends;
a plurality of radial seals arranged in the plurality of posts; and
a plurality of axial seals arranged in the busbar support plate.

2. The electric motor of claim 1, wherein the opening is one or a plurality of openings, and wherein the busbar support plate is a single piece comprising the plurality of openings through which the plurality of posts extends.

3. The electric motor of claim 1, wherein the busbar support plate is in face-sharing contact with an outer surface of the cover.

4. The electric motor of claim 1, wherein the busbar assembly is welded to a plurality of windings.

5. The electric motor of claim 1, wherein the plurality of radial seals is configured to seal an interface between the plurality of posts and the busbar support plate.

6. The electric motor of claim 1 wherein the plurality of axial seals is configured to seal an interface between the busbar support plate and the cover.

7. The electric motor of claim 1, wherein the plurality of posts comprises through-holes through which cables extend.

8. The electric motor of claim 1, wherein the busbar support plate is an overmold.

9. A system, comprising:
a plurality of posts that protrudes through a housing of an electric motor and a motor cover; and
a busbar support plate arranged radially about the plurality of posts and in face-sharing contact with an outer surface of the motor cover.

10. The system of claim 9, wherein the plurality of posts comprises tapped holes configured to receive cables, and wherein the plurality of posts extends to a stator busbar assembly.

11. The system of claim 9, wherein the plurality of posts comprises grooves in which a plurality of radial seals is arranged, wherein the plurality of radial seals is in face-sharing contact with the plurality of posts and the busbar support plate.

12. The system of claim 9, wherein the busbar support plate comprises grooves in which a plurality of axial seals is arranged, wherein the plurality of axial seals is in face-sharing contact with the busbar support plate and the motor cover.

13. The system of claim 9, wherein the plurality of posts extends through a plurality of chambers of the busbar support plate.

14. The system of claim 13, wherein the busbar support plate comprises a web-structure between the plurality of chambers and an outer rim.

15. The system of claim 9, wherein the busbar support plate is symmetric.

16. An electric motor, comprising:
a stator busbar assembly arranged in a housing of the electric motor;
a busbar support plate arranged in face-sharing contact with an outer surface of a motor cover coupled to the housing; and
a plurality of posts that protrudes through the housing and the motor cover and extends to the stator busbar assembly.

17. The electric motor of claim 16, wherein the plurality of posts comprises grooves in which a plurality of radial seals is arranged, wherein the plurality of radial seals is in face-sharing contact with the plurality of posts and the busbar support plate.

18. The electric motor of claim 16, wherein the busbar support plate comprises grooves in which a plurality of axial seals is arranged, wherein the plurality of axial seals is in face-sharing contact with the busbar support plate and the motor cover.

19. The electric motor of claim 16, wherein the plurality of posts integrated into the stator busbar assembly.

20. The electric motor of claim 16, wherein each of the plurality of posts is individually fastened to the stator busbar assembly, and wherein each post of the plurality of posts comprises a sealing plate with axial and radial seals.
